(19) United States
(12) Patent Application Publication
(10) Pub. No.: US 2024/0320843 A1
(43) Pub. Date: Sep. 26, 2024

(54) CATEGORY AND JOINT AGNOSTIC RECONSTRUCTION OF ARTICULATED OBJECTS

(71) Applicant: Toyota Research Institute, Inc., Los Altos, CA (US)

(72) Inventors: Thomas KOLLAR, San Jose, CA (US); Nick HEPPERT, Freiburg i. B. (DE); Muhammed Zubair IRSHAD, Atlanta, GA (US); Rares A AMBRUS, San Francisco, CA (US); Katherine LIU, Mountain View, CA (US); Jeannette BOHG, San Francisco, CA (US); Sergey ZAKHAROV, San Francisco, CA (US)

(73) Assignees: Toyota Research Institute, Inc., Los Altos, CA (US); Toyota Jidosha Kabushiki Kaisha, Aichi-Ken (JP); The Board of Trustees of the Leland Stanford Junior University, Stanford, CA (US)

(21) Appl. No.: 18/441,589

(22) Filed: Feb. 14, 2024

Related U.S. Application Data
(60) Provisional application No. 63/491,347, filed on Mar. 21, 2023.

(51) Int. Cl. G06T 7/50; B25J 9/16; G06T 7/70; G06T 15/00; G06V 10/77; G06V 10/774; G06V 10/82

(52) U.S. Cl. CPC G06T 7/50; B25J 9/1697; G06T 7/70; G06T 15/00; G06V 10/7715; G06V 10/774; G06V 10/82; G06T 2207/10012; G06T 2207/10024; G06T 2207/10028; G06T 2207/20081; G06T 2207/20084

(57) ABSTRACT

Aspects of the present disclosure provide techniques for category and joint agnostic reconstruction of articulated objects. An example method includes obtaining images of an environment having objects and generating, using a trained AI encoder, first information associated with the images based at least in part on the images, the first information comprising a plurality of joint codes and a plurality of shape codes associated with the images. The method further includes generating, using a trained AI decoder, second information associated with the objects based at least in part on the plurality of joint codes and the plurality of shape codes, the second information comprising shape information, one or more joint types, and one or more joint states corresponding to at least one of the objects. The method further includes storing the second information in memory.

### CROSS-REFERENCE TO RELATED APPLICATION(S)

The present Application for Patent claims benefit of U.S. Provisional Application No. 63/491,347, filed Mar. 21, 2023, which is hereby expressly incorporated by reference herein in its entirety.

### TECHNICAL FIELD

The present disclosure generally relates to computer vision, and more particularly, to computer vision capable of articulated object detection and reconstruction.

### BACKGROUND

Computer vision is used in a variety of technological areas including, for example, robotics manipulation, autonomous vehicle controls, augmented reality, virtual reality, mixed reality, visual surveillance, and scene understanding. Computer vision involves methods for acquiring, processing, analyzing and understanding digital images. In some cases, computer vision may be tasked with identifying characteristics associated with a particular object from visual observations (e.g., digital images) of an environment (virtual or real). Some of the computer vision tasks may include three-dimensional (3D) shape reconstruction, six degrees-of-freedom (6D) pose estimation, and/or size estimation, for example. As an example, these computer vision tasks may enable a robotics system to obtain a fine-grained understanding of its surrounding environment and facilitate manipulation of the robotics system (e.g., moving around objects) and/or objects (e.g., moving objects) detected in the environment.

### SUMMARY

Some aspects provide a method. The method includes obtaining one or more images of an environment having one or more objects. The method further includes generating, using a trained artificial intelligence (AI) encoder, first information associated with the one or more images based at least in part on the one or more images, the first information comprising a plurality of joint codes and a plurality of shape codes associated with the one or more images. The method further includes generating, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects. The method further includes storing the second information in memory.

Some aspects provide a system. The system includes one or more memories and one or more processors coupled to the one or more memories. The one or more processors are configured to cause the system to obtain one or more images of an environment having one or more objects; generate, using a trained artificial intelligence (AI) encoder, first information associated with the one or more images based at least in part on the one or more images, the first information comprising a plurality of joint codes and a plurality of shape codes associated with the one or more images; generate, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects; and store the second information in memory.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an example robotic system;

FIGS. 2A and 2B depict an example encoder-decoder architecture for category and joint agnostic reconstruction of articulated objects (CARTO);

FIGS. 3A and 3B depict an example encoder processing architecture;

FIG. 4 depicts an example decoder processing architecture;

FIG. 5 depicts joint codes predicted using a decoder trained through joint space regularization;

FIG. 6 depicts example operations for CARTO; and

FIG. 7 depicts an example processing system.

### DETAILED DESCRIPTION

Aspects of the present disclosure provide systems, methods, and computer-readable mediums for articulated object reconstruction from a digital observation of an environment.

Reconstructing three-dimensional (3D) shapes and estimating the six-degrees-of-freedom (6D) pose and sizes of objects from visual observations (e.g., digital images) of an environment may pose challenges in computer vision, for example, for robotics manipulation, augmented reality (AR), virtual reality (VR), mixed reality (MR), and/or computer generated imagery (e.g., video games). Object-centric 3D scene understanding may be challenging, especially for artificial intelligence (AI) based computer vision systems, as inferring 6D pose and shape can be ambiguous without prior knowledge about the object of interest.

Some computer vision systems may perform category-level 3D shape reconstruction and 6D pose estimation in real-time, enabling the reconstruction of complete, fine-grained 3D shapes and textures. However, there are a wide variety of real-world objects that do not have a constant shape but can be articulated according to the object's underlying kinematics, such as a laptop computer, dishwasher, pantry or cupboard, microwave, dresser, etc. Some computer vision systems perform articulated object tracking and reconstruction from a sequence of observations. However, a sequence of observations may be cumbersome due to dependence on prior interaction with the environment to form the sequence of observations.

Some computer vision systems may perform articulated object reconstruction from a single observation use a two-stage approach. First, objects are detected, for example, using a mask region-based convolutional network. Then, based on the detection output, object properties (e.g., part-poses and normalized object coordinate space (NOCS) maps) may be predicted, and the object is reconstructed using backward optimization. Such a two-stage approach may be complex and error prone, and such an approach may not scale across many categories and may not be capable of being implemented in real-time (e.g., performing the reconstruction in less than 1 second).

Aspects of the present disclosure provide techniques for obtaining 3D information associated with multiple articulated objects from a single visual observation (e.g., stereo images and/or a red-green-blue-depth (RGB-D) image) of a scene or environment, which may be referred to as category and joint agnostic reconstruction of articulated objects (CARTO). The CARTO system as described herein may generate the 3D information per object including, for example, joint type, joint state, 3D shape, 6D pose, and/or size. The CARTO system may include an AI-based image encoder and an AI-based latent code decoder, which may be or include a robust category-agnostic (e.g., capable of detecting multiple categories of objects) and joint-agnostic (e.g., capable of detecting multiple joint states) 3D decoder. As an example, the multiple categories may include dishwasher, washing machine, microwave, oven, laptop, table, refrigerator, etc. The CARTO system may train the AI-based latent code decoder by learning disentangled latent shape and joint codes, as further described herein. The shape code may encode the canonical shape of an object, and the joint code may represent the articulation state of the object including, for example, the type of articulation (e.g., prismatic or revolute) and the amount of articulation (e.g., angular displacement or linear displacement). To disentangle the latent codes, the CARTO system may impose structure among the learned joint codes by using a physically grounded regularization term. In combination with the image encoder, the CARTO system may perform inference in a single-shot manner (e.g., detecting multiple properties associated with multiple objects in parallel) to detect the objects' spatial centers, 6D poses, sizes in addition to the shape codes and joint codes. The shape codes and joint codes may be used as input to the AI-based latent code decoder to reconstruct the objects and infer joint states associated with the detected objects, as further described herein.

The techniques for CARTO described herein may provide any of various advantages and/or beneficial effects. The techniques for articulated object reconstruction may facilitate articulated object reconstruction in an object category agnostic (e.g., an AI model that supports multiple object categories) and a joint agnostic manner (e.g., an AI model that supports multiple joint types, such as prismatic and revolute), as further described herein. The techniques for articulated object reconstruction may allow for identifying the joint of an object in real-time (e.g., less than a second of processing), and thus, allow the articulated object reconstruction to be implemented in applications for robotic manipulation, AR, VR, and/or MR. The techniques for articulated object reconstruction may allow for joint identification without prior interaction with the environment, for example, through the use of stereo images and/or an RGB-D image as input instead of video images. For example, object reconstruction from a single (stereo) image through inferring latent information about an object a priori enables both grasping and manipulation of previously unknown articulated objects. Additionally, estimates from a single (stereo) image can serve as a good initial guess for object tracking approaches.

### Example Robotic System

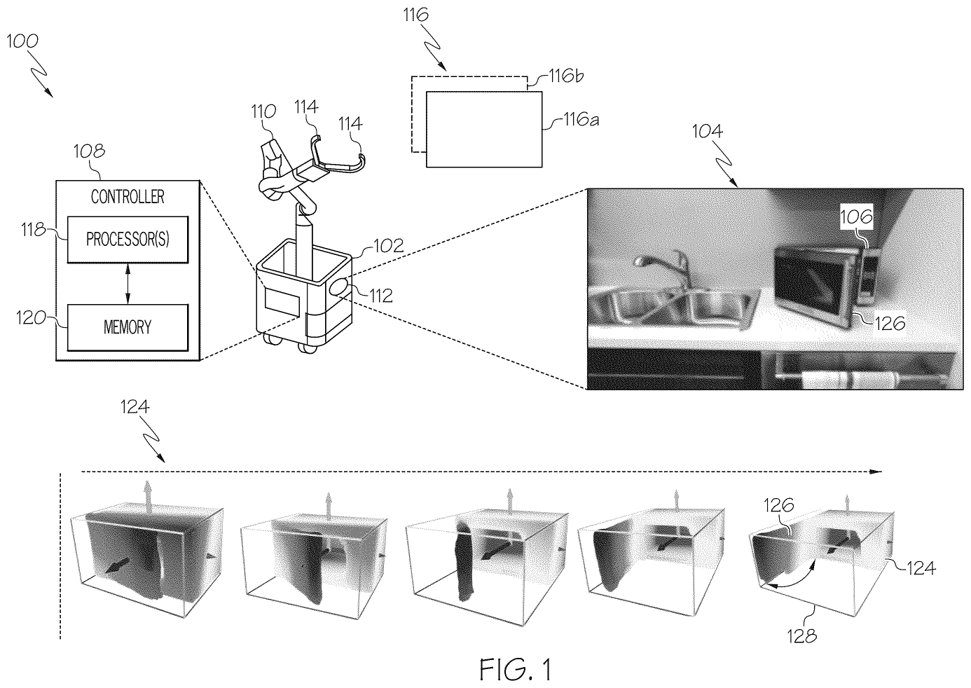

FIG. 1 depicts an example a robotic system 100 that employs CARTO for computer vision. In this example, the robotic system 100 may include a robot 102 arranged in an environment 104 with an object 106. The robot 102 includes a controller 108, an arm 110, and a camera 112. In some cases, the robot 102 may be capable of moving, for example, via any of various mechanisms of robotic locomotion, such as drive wheel(s), walking, etc.

The arm 110 may include one or more end effectors 114 that move away from and towards one another in order to grasp, move, rotate, and otherwise manipulate various external objects (e.g., the object 106). In some cases, the arm 110 may be articulated, for example, with six axes of articulation. The arm 110 may include three rotary joints, which may be actuated by motors and/or other actuator(s). In certain aspects, the end effector 114 on the arm 110 of the robot 102 may be in the form of deformable grippers that include deformable sensors disposed thereon. The deformable sensors may be positioned within each of the deformable grippers and may be a camera or a comparable sensor that is capable of high spatial resolution. The deformable sensor positioned within each of the deformable grippers may be a dense tensile sensing sensor that provides the robot with a fine sense of touch, e.g., comparable to the touch associated with a human's fingers. The deformable sensor may also have a depth resolution for measuring movement towards and away from the sensor.

The robot 102 may capture one or more images 116a, 116b (collectively the images 116) of the environment 104 using the camera 112. In some cases, the camera 112 may include multiple cameras arranged to provide overlapping (or non-overlapping) fields of view, for example, with binocular vision. The binocular vision may enable the capture of the images 116 as stereo images, which may include a stereopair of digital photographs. As an example, the stereo images may include a left image 116a, which may be captured by a first camera (not shown), and a right image 116b, which may be captured by a second camera (not shown) displaced from the first camera. In certain cases, the images 116 may be or include an RGB-D image.

The controller 108 may include one or more processors 118 (collectively the processor 118) and one or more memories 120 (collectively the memory 120) coupled to the processor 118. The memory 120 may store processor-executable instructions that when executed by the processor 118 cause the robot 102 to perform any of the operations described herein.

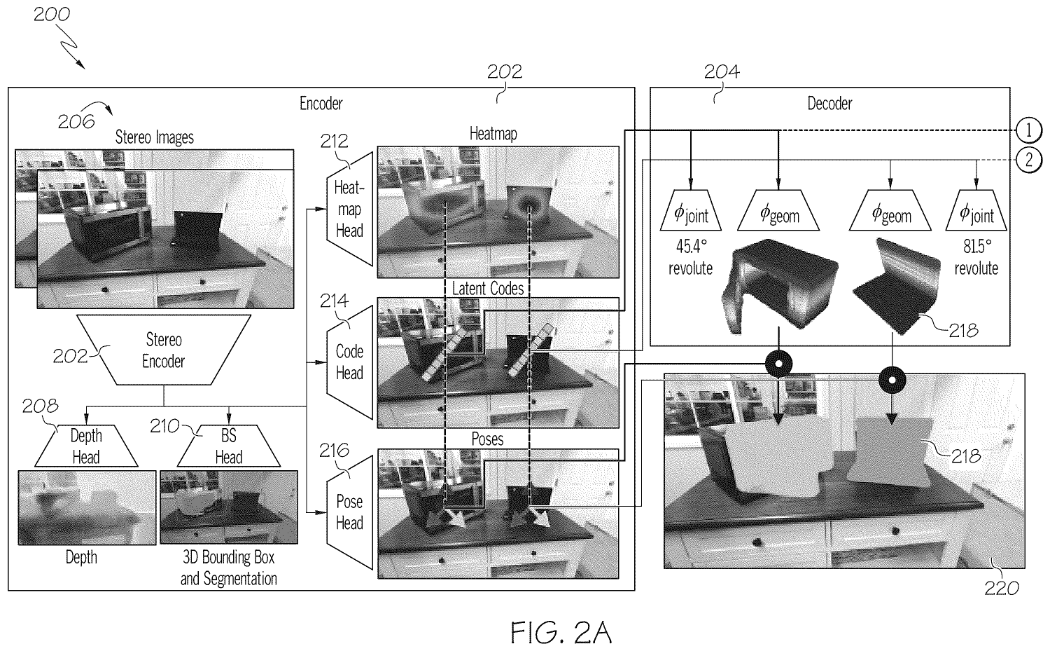

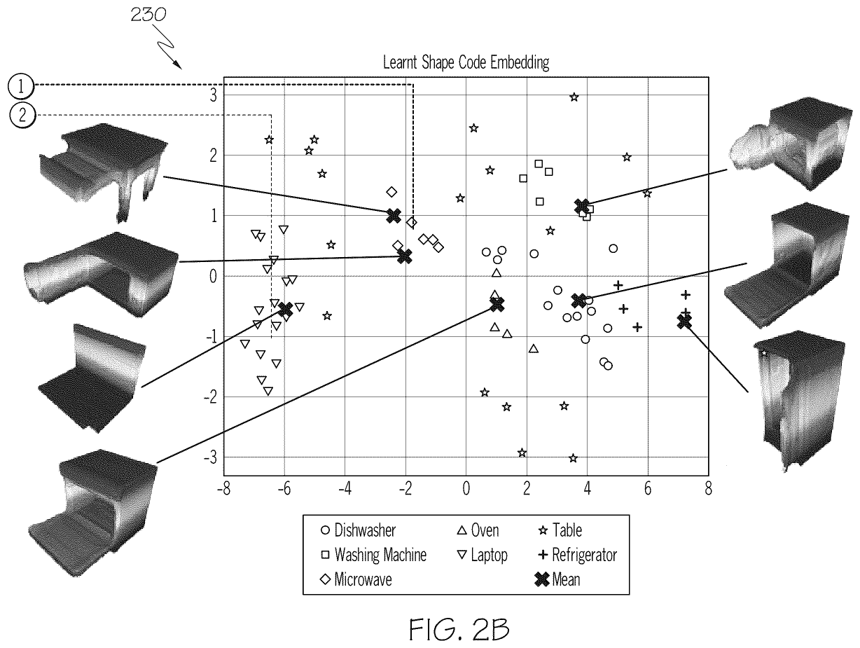

The controller 108 may control the movement(s) of the robot 102, for example, through the techniques of computer vision including CARTO as further described herein with respect to FIGS. 2A-5. As an example, the controller 108 may obtain the images 116 captured via the camera 112. The controller 108 may perform CARTO operations on the images 116 to generate a digital 3D reconstruction 124 of the object 106, for example, simulated at various stages of articulation (e.g., angular displacement). The CARTO operations described herein may include an AI-encoder-decoder pipeline to predict the joint type and joint state of the object 106. For example, the CARTO operations may predict that the object 106 has a door 126 with a revolute joint. The simulation may project the door 126 of the object at different states of articulation (e.g., angular displacements). Through simulation, the articulation states may be observed in a bounding box 128 to predict the articulation range of the object's door 126. Using the 3D information, the controller 108 may provide instructions to the arm 110 and/or the effector 114 to manipulate (e.g., open and/or close) the door 126 of the object 106 using the predicted articulation range of the door 126 to determine the corresponding motion of the arm 110.

In certain aspects, the CARTO operations described herein may facilitate other applications in addition to or instead of computer vision for robotic system controls. For example, the articulated object may be reconstructed in a virtual environment (for example, for VR, AR, and/or computer animations), and virtual objects may be displayed inside the articulated object. With respect to FIG. 1, where the articulated object 106 is depicted as a microwave, the CARTO operations may allow the microwave to be digitally represented with another virtual object inside the microwave (e.g., a cup of tea or coffee). As the door 126 is articulated at different angular displacements, the other object may be revealed or concealed depending on whether the door 126 is being closed or opened. As such, some of the image(s) provided as input to the CARTO system described herein may be virtual images (e.g., computer-generated imagery (CGI)).

### Example Computer Vision System

FIGS. 2A and 2B illustrate an example CARTO architecture 200. In some cases, the CARTO architecture 200 may be implemented in a robotic system 100, for example, in part as processor-executable instructions stored in the memory 120. In this example, the CARTO architecture 200 includes an AI processing pipeline having an AI encoder 202 and an AI decoder 204.

In certain aspects, the AI encoder 202 obtains stereo images 206 (e.g., the images 116 of FIG. 1) of an environment as input. As an example, the images 206 depict at least one articulated object, such as the object 106 of FIG. 1. In some cases, the images 206 may not depict an articulated object, and in such cases, the CARTO architecture 200 may be trained or configured to indicate that there is no articulated object in the images 206. The stereo images 206 may allow the detection of objects in harsh lighting conditions and/or detection of transparent or reflective objects. In some cases, the AI encoder 202 obtains a single RGB-D image as input. As previously discussed, the image(s) 206 may be captured via one or more cameras. Additionally or alternatively, the image(s) 206 may be computer-generated imagery. In general, the AI encoder 202 predicts certain information associated with the images 206, for example, using a depth head 208, a bounding box and segmentation (BS) head 210, a heatmap head 212, a code head 214, and/or a pose head 216. As an example, the AI encoder 202 predicts latent object codes as well as poses in a view frame. The encoder-predicted information may include a depth map, a bounding box and segmentation mask, a heatmap, a shape code, a joint code, and/or a pose. The bounding box and segmentation head 210 may provide a segmentation mask and a 3D bounding box for each inferred object in the images 206. The code head 214 may provide a shape code and a joint code for each inferred object. The bounding box and segmentation predictions may be used to construct a baseline for evaluating the performance of CARTO at predicting the joint information.

In certain aspects, the encoder 202 predicts a depth (e.g., using the depth head 208), an importance value (e.g., using the heatmap head 212), a pose (e.g., using the pose head 216), a shape code (e.g., using the code head 214), and joint code (e.g., using the code head 214) for each pixel. For each pixel in the input stereo image I^{W×H×6}, the encoder 202 predicts an importance scalar ψ. where a higher value indicates closeness to a 2D spatial center in the image of the object. The full output map of ψ represents a heatmap over objects, for example, the heatmap head 212. The encoder 202 predicts a dense pixel map of canonical 6D poses (e.g., using the pose head 216) for each articulated object independent of their articulation state. The encoder 202 predicts object codes (e.g., using the code head 214) including a shape code zₛ ∈ [symbol] ^{Ds} and a joint code zⱼ ∈ [symbol] ^{Dj} for each pixel. The object codes may be used to predict the articulation state of the object as further described herein with respect to the decoder 204. In some cases, to guide the encoder network towards geometric object features, the encoder 202 predicts a semantic segmentation mask and 3D bounding boxes, again on a pixel-level, using the BS head 208. Using depth head 208, the encoder 202 may predict a depth map D^{W×H} of the stereo image 206.

During inference of the encoder pipeline, given the predicted heatmap of importance values, the encoder 202 may use non-maximum suppression to extract peaks in the images. For example, using peak detection on the depth map, the encoder 202 may detect objects which then can be reconstructed given the latent code, as further described herein. At each peak, the encoder 202 may query the feature map to get the pose, shape, and joint code. As an example, the encoder 202 may convert a 13-dimensional pose vector to a scale value ∈ [symbol] of the canonical object frame, a position ∈ [symbol] ³ and using, for example, deep regression on manifolds to an orientation ∈ [symbol] ^{3x3} in the camera frame. The decoder 204 may use the shape and joint code to reconstruct each object in its canonical object frame, such as the reconstructed object 218, and the decoder 204 may use the joint code to infer the joint type and/or joint state. After reconstruction, the decoder 204 may use the predicted pose to place the reconstructed object 218 in an image frame 220, for example, in the frame of the stereo images 206 and/or virtual image(s). To place a digital representation of the objects in the image frame 220, the CARTO architecture 200 transforms the reconstructed point cloud using the predicted poses at the peaks, for example.

As shown in graph 230, the position of the predicted shape codes are plotted as a t-distributed stochastic neighbor embedding (t-SNE) visualization of the learned shape codes of or from a training object set. The graph 230 demonstrates that different object categories exhibit different shape codes. For example, the shape codes for the laptop category are arranged on the opposite side of the graph 230 compared to the shape codes for refrigerator. Therefore, the shape codes and the joint codes may be used to predict the category type, joint state, and/or joint type, as further described herein. In some cases, the predicted shape codes may be used to train the CARTO decoder 204, as further described herein. The CARTO architecture 200 projects mean shape codes for each of the object categories and use the means to reconstruct the objects at the average prismatic and revolute joint state, for example, in a training set.

### Example Encoder

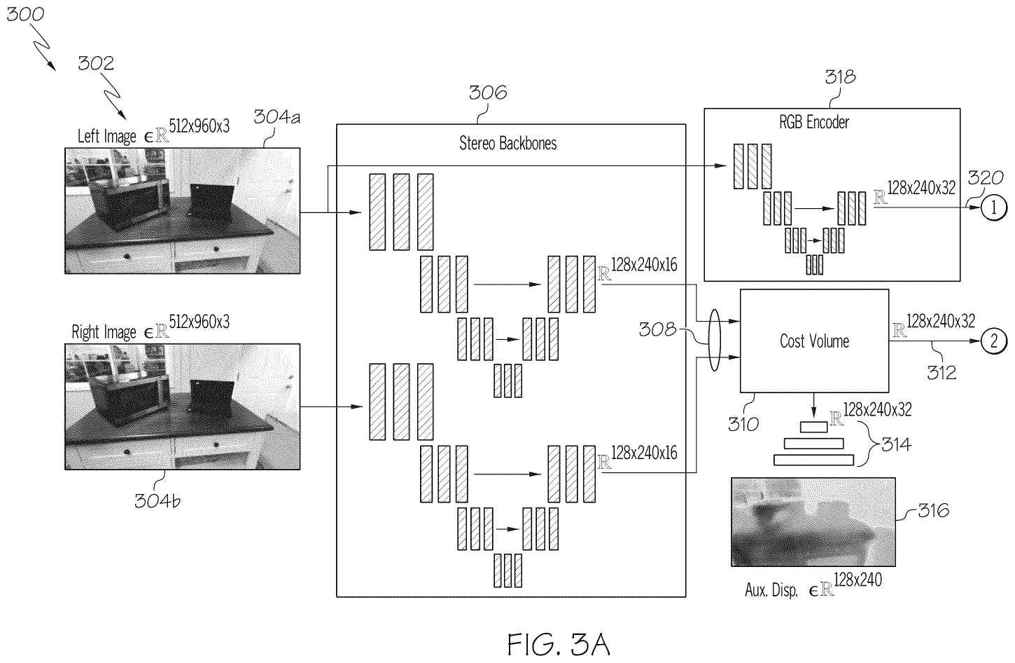

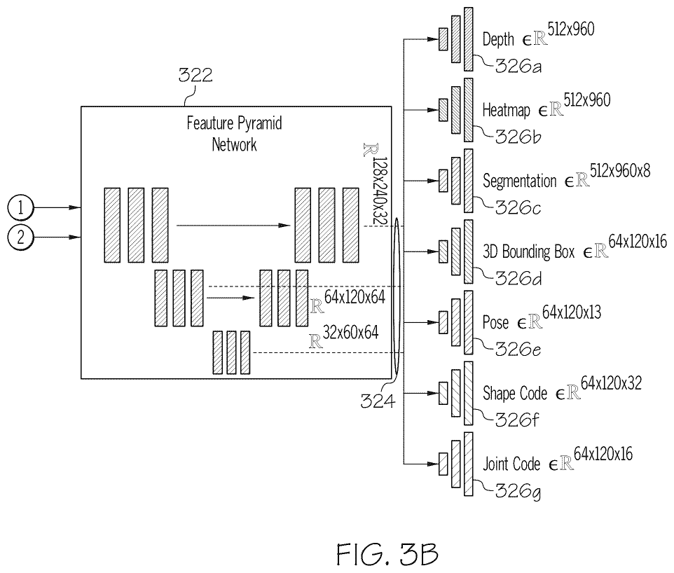

FIGS. 3A and 3B illustrate an example CARTO encoder 300. In this example, the encoder 300 obtains input 302 that includes stereo RGB images 304a, 304b (e.g., each image 304a, 304b having a size [symbol] ^{960×512×3}). Each image 304a, 304b is passed through a shared feature encoder network 306 (e.g., a neural network pipeline for each image) that outputs a first feature map 308 for each of the images 304a, 304b. The feature encoder network 306 may be or include a residual neural network (ResNet) (e.g., ResNet-50), a deep-convolutional neural network with skip connections, and/or a transformer for each image. As an example, each of the first feature maps 308 may be low-dimensional with respect to the source images and have a size of [symbol] ^{128×240×16}. The first feature maps 308 are then fed into a cost volume calculator 310, which performs approximate stereo matching between the first feature maps 308 to determine a cost volume 312. Based on the cost volume 312 (e.g., a cost volume having a size of [symbol] ^{128×240×32}), a lightweight head 314 (e.g., a neural network) predicts an auxiliary disparity map 316 of size [symbol] ^{128×240} (e.g., a depth map).

One of the images 304a, 304b (e.g., the left image 304a) is passed through a separate RGB encoder 316 (e.g., a neural network, ResNet, etc.) that predicts a second feature map 320, for example, RGB features. As an example, the second feature map 320 may have a size of [symbol] ^{128×240×32} The RGB encoder 318 may process the image 304a in parallel with the feature encoder network 306 and/or the cost volume calculator 310. For example, as the feature encoder network 306 processes the stereo images (304a, 304b), the RGB encoder 316 may process the single image 304a. The second feature map 320, as well as the cost volume 312, are combined (e.g., concatenated) and fed into a feature pyramid network 322, which predicts multiple feature maps 324 of different scales (sizes), for example, a pyramid of three feature maps having sizes of [symbol] ^{128×240×32}, [symbol] ^{64×120×64}, and [symbol] ^{32×60×64}. In this example, the feature pyramid network 322 may take as input the cost volume 312 and the second feature map 320 and output proportionally sized feature maps 324. The pyramid of feature maps 324 may include a first feature map having a first size, a second feature map having a second size, and a third feature map having a third size, where the first size is greater than the second size, and the second size is greater than the third size.

Using the feature pyramid (e.g., the feature maps 324), each quantity as described herein with respect to FIGS. 2A and 2B is predicted by the respective output head (e.g., each output head includes a neural network having one or more layers), including a full resolution disparity head 326a (e.g., depth), a heatmap head 326b, a segmentation mask head 326c, 3D bounding box head 326d, object pose head 326e, shape code head 326f, and joint code head 326g.

### Example Decoder

Given a latent code (e.g., a shape code and a joint code) predicted using an encoder (e.g., the encoder 300), the CARTO decoder reconstructs object geometry, classifies the discrete joint type (e.g., as prismatic or revolute), and predicts the continuous joint state (e.g., an angular displacement or translation displacement). To disentangle the shape of the object from the articulation state, the latent code is split into two separate codes: a shape and a joint code. The same unique shape code zₛ∈ [symbol] ^{Ds} may be assigned to an object instance in different articulation states, where an articulation state is expressed through a joint code variable zⱼ∈ [symbol] ^{Dj}. The decoder includes two sub-decoders, one for reconstructing the geometry and the other for predicting the joint type jt and state q. As discussed with respect to FIGS. 2A and 2B, the decoder may reconstructs objects in a canonical frame that can be transformed into the image frame (e.g., a camera frame and/or a virtual frame) through the predicted pose.

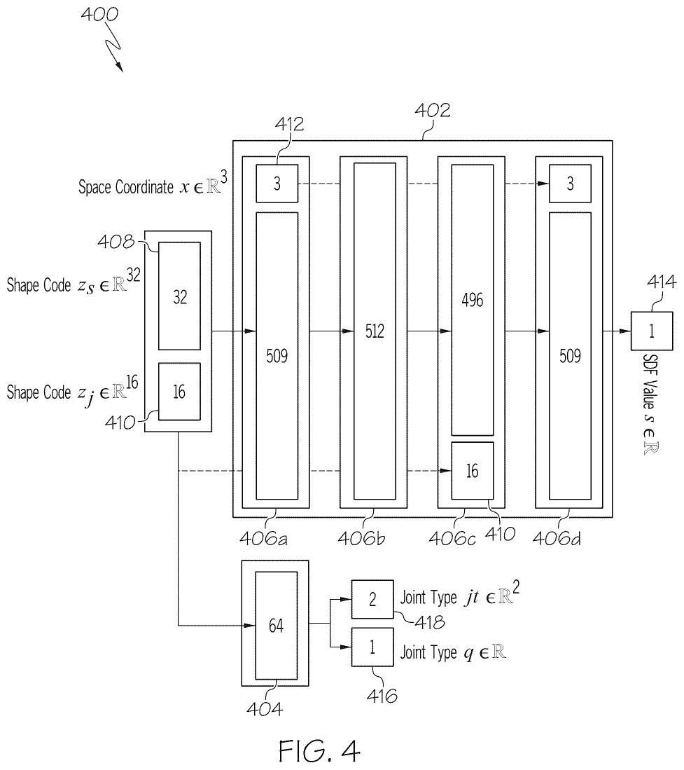

FIG. 4 illustrates a diagram of an example CARTO decoder 400. The decoder 400 includes a geometry decoder 402 and a joint decoder 404. The geometry decoder 402 may be based on a learned neural implicit function (e.g. a continuous signed distance function (SDF)). The geometry decoder ϕ_{geom} reconstructs objects based on a shape code zₛ and joint code zⱼ. In certain aspects, the geometry decoder uses SDFs, for example, due to the effective performance of SDFs. Specifically, in the case when using SDFs as the geometry decoder, the model takes as input a point in 3D space x as well as a shape zₛ and joint code zⱼ:

$${ϕ}_{g e o m} ( {z}_{s} , {z}_{j} , x ) = {\hat{s}}_{x} \qquad ( 1 )$$

and predicts a value ŝₓ that indicates the distance to the surface of the object. Note that the geometric decoding described herein may be agnostic to the specific decoder architecture used as long as the decoding technique is differentiable with respect to the input latent codes (e.g., the shape code and the joint code). For example, various geometry decoders may be used, such as occupancy maps.

For faster inference, the geometry decoder may implement a multi-level refinement procedure. The geometry decoder first samples query points on a coarse grid and refines them around points that have a predicted distance within half of the boundary to the next point. This operation can be repeated multiple times to refine the object prediction up to a specified level of granularity. Eventually, the geometry decoder may extract the surface of the objects by selecting all query points x for which |sₓ|<ϵ holds. By taking the derivative:

$${n}_{x} = \frac{\partial {ϕ}_{g e o m} ( {z}_{s} , {z}_{j} , x )}{\partial x} \qquad ( 2 )$$

and normalizing it, the geometry decoder obtains the normal \hat{n}ₓ at each point x, which can then be used to project the points onto the surface of the object with \hat{x}=x−ŝₓ\hat{n}ₓ.

The geometry decoder 402 may be or include a deep multi-layer perceptron comprising multiple layers 406a-d (collectively the layers 406) arranged in a processing pipeline of the geometry decoder 402. As an example, the geometry decoder 402 may include four layers 406 arranged in a series of processing elements. The first layer 406a in terms of the processing pipeline (e.g., the initial layer of the processing pipeline) may obtain a shape code zₛ 408 and joint code zⱼ 410 as input and may produce an SDF value s of the output 414. Before the second and last layer 406b, 406d (in terms of the processing pipeline), the geometry decoder 402 may concatenate the space coordinate 412 x. The third layer 406c (in terms of the processing pipeline) may take as additional input the joint code 410 zⱼ and the output of the second layer 406b. As activation functions, the geometry decoder 402 may use a rectified linear activate function (ReLU), a sigmoid function, and/or a hyperbolic tangent (tanh) function. For example, the first three layers 406a-c may use the ReLU, and the last layer 406d may use tanh.

As the encoder provides a joint code zⱼ, which is indicative of an articulation state of the object, the decoder 400 employs an articulation state decoder ϕⱼₒᵢₙₜ to regress a discrete joint type jt={prismatic, revolute} and a continuous joint state q:

$${ϕ}_{joint} ( {z}_{j} ) = \hat{J t} , \hat{q} \qquad ( 3 )$$

The joint decoder 404 takes the joint code zⱼ 410 as input and feeds the joint code zⱼ 410 through a single layer outputting a feature vector, for example, with 64 dimensions. For example, the joint decoder 404 may use a multi-layer perceptron (MLP), for example, with 64 neurons in one hidden layer. The feature vector may then be used to regress the articulation state comprising the continuous joint state 416 q and the discrete joint type 418 jt. The joint state 416 q may be determined without an activation function, whereas the joint type 418 jt may be determined using an activation function, such as a sigmoid activation.

### Example Training Operations

To train a CARTO system, the decoder may be trained initially as the decoder can provide ground truth training labels for the shape and joint code supervision of the encoder. Once shape and joint code labels are obtained for the objects in the dataset, the encoder may be trained to predict the latent codes in addition to object pose.

### Decoder Training

Given a training set of M objects each in N articulation states, the m-th object may be denoted in its n-th articulation state as x_{m,n}. As during training, a fixed association between each object and its latent codes is given, an object can be uniquely identified as a tuple of joint code and shape code (e.g., x_{m,n}=(zₛ^{m}, zⱼⁿ)). This allows the gradient to be passed all the way to the codes themselves and thus, the embedding spaces rearrange them accordingly. During training, the codes may be regularized through minimizing the L2-norm:

$${ℒ}_{r e g} ( z ) = ‖ z ‖ \qquad ( 4 )$$

where z is either zₛ or zⱼ. The geometry decoder (for example, as described herein with respect to FIG. 4) may be trained on a set of query points x close to the object surface sampled. A reconstruction loss [symbol] _{rec} may be defined using a leaky clamping function:

$${clamp}_{l} ( s \vert δ , α ) = \{ \begin{matrix}s & \vert s \vert \leq δ \\ α s & \vert s \vert > δ\end{matrix} \qquad ( 5 )$$

which is conceptually similar to a leaky ReLU by instead of hard clamping values above a threshold 8, these values may be multiplied by a small factor a. Initial testing revealed a more stable training. Thus, the reconstruction loss at one query point x may be given by:

$${ℒ}_{r e c} ( {z}_{s} , {z}_{j} , x , {s}_{x} ) = \vert {clamp}_{l} ( {ϕ}_{g e o m} ( {z}_{s} , {z}_{j} , x ) \vert δ , α ) - {clamp}_{l} ( {s}_{x} \vert δ , α ) \vert \qquad ( 6 )$$

where sₓ is the ground truth distance to the surface. The joint decoder (for example, as described herein with respect to FIG. 4) may be jointly trained with the aforementioned geometry decoder. For the joint type loss [symbol] ⱼₜ, a cross entropy may be used between the predicted joint type [symbol] and ground truth jt. For the joint state loss [symbol] _{q}, the L2-norm may be used between the predicted joint state \hat{q} and ground truth q.

### Joint Space Regularization

In certain aspects, the training operations may impose structure in the joint code space during the decoder training. Here, the training operations may enforce the same similarity of latent codes as their corresponding articulations states have. In general, the joint codes of two similarly articulated objects are expected to be close to each other. As an example, the similarity may be defined through the joint type jt and through an exponential distance measure of the joint state q. Formally, given the joint codes zⱼ^{k} and zⱼ^{l} encoding two different articulation states k, l ∈1, . . . , N, the similarity between latent codes in latent space may be defined as:

$$s i {m}_{latent} ( {z}_{j}^{k} , {z}_{j}^{l} ) = exp ( \frac{‖ {z}_{j}^{k} - {z}_{j}^{l} ‖}{σ} ) \qquad ( 7 )$$

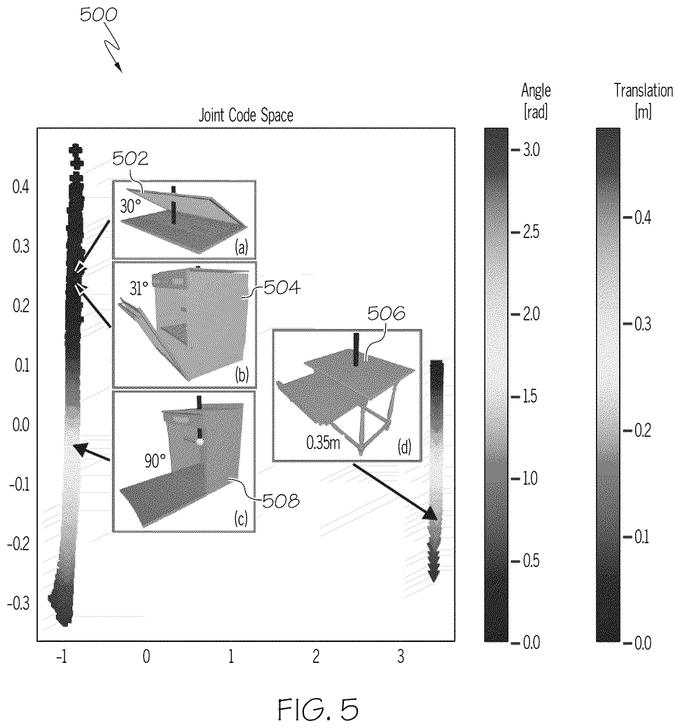

A visualization of the similarities of latent codes for different objects is shown in FIG. 5.

Similarly, the respective similarity in real joint space, considering the joint types jt^{k} and jt^{l} and the joint states q^{k} and q^{l}, may be defined through:

$$s i {m}_{r e a l} ( ( {jt}^{k} , {q}^{k} ) , ( {jt}^{l} , {q}^{l} ) ) = \{ \begin{matrix}exp ( - {( \frac{{q}^{k} - {q}^{l}}{{σ}_{jt}} )}^{2} ) & {jt}^{k} = j {t}^{l} \\ 0 & j {t}^{k} \neq j {t}^{l}\end{matrix} \qquad ( 8 )$$

where σⱼₜ is a joint type specific scaling. By minimizing the L1-norm between both similarity measurements, a joint space regularization loss may be given as:

$${ℒ}_{j r} ( {z}_{j}^{k} , {z}_{j}^{l} ) = \vert {sim}_{latent} ( {z}_{j}^{k} , {z}_{j}^{l} ) - s i {m}_{r e a l} ( ( {jt}^{k} , {q}^{k} ) , ( {jt}^{l} , {q}^{l} ) ) \vert$$

The training operations may enforce that the latent similarities are similarly scaled as their real similarities. This formulation may be scaled to all articulation states in the training set as described below. Calculating simᵣₑₐₗ can be done once in a pre-processing operation for all articulation state pairs k, l ∈1, . . . , N, resulting in a matrix Sᵣₑₐₗ ∈ [symbol] ^{N×N}. Similarly, calculating all simₗₐₜₑₙₜ-pairs can be efficiently implemented as a vector-vector product. The resulting matrix as Sₗₐₜₑₙᵣ∈ [symbol] ^{N×N}. Eq. (9) may be simplified to the following:

$${ℒ}_{j r} = \frac{\vert {S}_{latent} - {S}_{r e a l} \vert}{{N}^{2}} \qquad ( 10 )$$

Through this efficient calculation, optimizing this loss term comes with almost no overhead during training. This concept of similarity can be extended for arbitrary kinematic graphs.

FIG. 5 depicts example effects of latent space regularization. In this example, the decoder is trained using the joint space regularization described above. Graph 500 illustrates a two-dimensional projection based on singular value decomposition of the training joint codes including joint codes of a laptop 502, an oven 504, a table 506, and a dishwasher 508 in specific joint states as depicted. The laptop 502 and the oven 504 have a revolute joint and are similarly wide open around 30°. The dishwasher 508 has a revolute joint and is opened at a greater angular displacement (e.g., 90°) than the other example revolute objects (the laptop 502 and the oven 504), and therefore, the dishwasher is expected to be relatively close to the other revolute objects in the joint space. Compared to that, the table 506 has a prismatic joint, and thus is not expected to be close to the revolute instances.

As shown, the joint codes for the revolute objects (e.g., the laptop 502, oven 504, and dishwasher 508) are positioned within the same region along the x-axis, whereas the joint codes of prismatic objects (e.g., the table 506) are in a different region along the x-axis. With respect to the differences in angular displacement, the joint codes of the laptop 502 and the oven 504 are positioned close together along the y-axis, whereas the joint codes of the dishwasher 508 is at a different region along the y-axis. Thus, the x-axis is indicative of the joint type, and the y-axis is indicative of the joint state.

### Pre-Training

Before the training is started for the full decoder (e.g., the geometry and joint decoders), only certain joint codes may be optimized zⱼⁿ ∀ₙ ∈1, . . . , N. The pre-training helps with learning the full decoder as the joint codes are already more structured and thus, it is easier to learn the shape and joint code disentanglement. In the pre-training, a pretraining loss may be minimized as

$${ℒ}_{p r e} = {δ}_{reg , {z}_{j} , pre} {ℒ}_{reg , {z}_{j}} + {δ}_{jr , pre} {ℒ}_{jr} \qquad ( 11 )$$

where [symbol] _{reg,zj} is the default norm regularization from Eq. (4) and [symbol] ⱼᵣ was introduced in Eq. (10).

### Loss Function

Given an object x_{m,n}, the full decoder loss may be expressed as:

$$ℒ = {δ}_{reg , {z}_{s}} {ℒ}_{reg , {z}_{s}} + {δ}_{reg , {z}_{j}} {ℒ}_{r e g , {z}_{j}} + {δ}_{r e c} {ℒ}_{r e c} + {δ}_{jt} {ℒ}_{jt} + {δ}_{q} {ℒ}_{q} \qquad ( 12 )$$

where [symbol] _{reg,z} are the shape and joint code regularization from Eq. (4), [symbol] _{rec} is the reconstruction loss introduced in Eq. (6), [symbol] ⱼₜ is joint type loss, and [symbol] _{q} is the joint state loss. We jointly optimize The full decoder loss [symbol] may be jointly optimized for the latent shape and joint code as well as the network parameters of the geometry decoder and joint decoder using the Adam optimization method for 5000 epochs (e.g., the number of epochs defines the number times that the learning algorithm will work through the entire training dataset). The joint code regularizer loss [symbol] ⱼᵣ introduced in Eq. (10) is minimized at the end of each epoch separately scaled by δⱼᵣ. All δ variables are scalars to balance the different loss terms, and example values for the scaling variables are provided in Table 1 below.

TABLE 1
Example Scaling Hyperparameters for Decoder Training

| Scaling Variable | Value |
|---|---|
| δ_{reg, zj, pre} | 0.1 |
| δ_{jr, pre} | 1.0 |
| δ_{reg, zs} | 0.0001 |
| δ_{reg, zj} | 0.001 |
| δ_{rec} | 1.0 |
| δⱼₜ | 0.001 |
| δ_{q} | 0.1 |
| δⱼᵣ | 0.1 |

### Encoder Training

A large-scale synthetic dataset may be used for encoder training. As an example, assuming the training dataset is of an indoor kitchen environment, the training data may include images of articulated objects instances from the following categories: dishwasher, laptop, microwave, oven, refrigerator, table, and washing machine. The same articulated object instances used for training the decoders may be used for training the encoder. Unlike the decoder training and evaluation, the placement type of the object may be used to sample a position for an articulated object in the scene. For each randomly sampled articulated object in the scene, the evaluation randomly samples a joint state in its joint limits as well as a scale from a pre-defined scale for each category. The inverse joint decoder technique as discussed herein is used to get ground truth joint codes for sampled articulation states. After sampling a scene, the evaluation generates noisy stereo images as well as non-noisy depth images (only used for evaluation of the baseline). Each pixel may be annotated with its respective ground truth value. For example, the results of the encoder training may be used for annotating the shape codes, whereas for the joint code, an inverse mapping (as further described herein) may be used to retrieve joint codes for arbitrary sampled articulation states.

### Backward Code Optimization

In certain cases, the CARTO system may determine the shape code zₛ^{u} and joint code zⱼ^{u} of an unknown object. For the task of canonical object reconstruction from a set of SDF values at specific query points, the decoder (400) may use a backwards optimization procedure to retrieve a shape and joint code.

The CARTO system may optimize multiple code hypotheses at once and pick the best one in the end. Additionally, the codes are not reset but rather freeze them for some iterations. During some testing, it was observed that first optimizing for both codes jointly together gives a good initial guess. Freezing the joint code in a second stage of optimization helps such that the shape fits the static part and then last, freezing the shape code such that the joint code can do some fine adjustment to the articulation state of the object. To guide the gradient in the joint code space, the space is transformed using a singular value decomposition of the stacked training joint codes zⱼⁿ∀∈1, . . . , N.

### Inverse Joint Decoder

To solve the inverse problem of determining a joint code based on an articulation state, polynomial functions may be fit in the learnt joint code space. With the help of this mapping, arbitrary joint codes can be retrieved and then may be combined with a shape code to reconstruct objects in novel articulation states which have not been seen during the decoder training. Additionally, the mapping may provide joint code training labels for the encoder.

The full mapping may be represented as a function ξ_{code}(it, q)=zⱼ that takes a joint type jt and joint state q as input and outputs a joint code zⱼ. Leveraging the fact that after decoder training, a joint code zⱼⁿ is learned for each known training articulation state. Individual mappings may be defined for each joint type jt the following way. Each latent dimension d is treated separately. For each dimension d, a polynomial function is fit ϵ_{code}^{jt}(q) of varying degree p through all point tuples (qⁿ, zⱼⁿ(d)) ∀ₙ ∈1, . . . , N. The mapping function is then given by evaluating the polynomials individually and stacking the results into a vector:

$${ξ}_{c o d e} ( jt , q ) = [ \begin{matrix}{ξ}_{code}^{jt , 1} ( q ) \\ ⋮ \\ {ξ}_{code}^{jt , {D}_{j}} ( q )\end{matrix} ] \qquad ( 13 )$$

The dimensions of the polynomial p may be selected such that the amount of joint codes to fit to is much higher than the potential dimensions of the polynomial p<<N. An example CARTO system may use a polynomial having p=5.

### Decoder Performance Evaluation

To evaluate the performance of the decoder, a synthetic object set of 3D models was used as a training data set and test data set. The synthetic object set includes more than 2000 objects from 46 object categories. A subset of the object set was used for training and testing. The final object set used for the evaluation included 92 objects instances for training and 25 for testing. From this subset of categories, objects with one fixed base part and one significant moving part were selected (additional moving parts like knobs, buttons, etc. were excluded). To later create realistic room layouts, the object set may include different placement types for objects, such as stand-alone (SA), counter (C) and table-top (TT) objects.

When tackling the task of reconstructing objects in a canonical object frame, usually, objects are canonicalized such that they either fit into the unit cube or unit sphere. This helps with the stability of learning and simplifies hyperparameter tuning. This approach fails for articulated objects as their outer dimensions change depending on the joint state. Blindly rescaling an articulated object such that it fits inside the unit cube or unit sphere results in an inconsistent part scaling across different joint states. To mitigate this problem, a normalized articulated object coordinate space (NOACS) is used. First, an object is arranged in its closed state (e.g., the lower joint limit) and in a canonical orientation such that for all objects, Z is pointing upwards and X back, Y is given through a right-hand coordinate frame system. The closed object is rescaled and translated such that it fits in the unit cube and then backwards apply that same rescaling and translation to all objects of the same instance independent of the joint state of the object. It is important to note that rescaling an articulated object has no impact on the measured angular displacement (in deg), but measured translation displacement (in m), which is rescaled accordingly.

The performance evaluation tested how well the decoders reconstruct the object's geometry and the articulation state. Thus, the task is not to reconstruct the object in the camera frame, but simply in its canonical frame. As described with respect to training operations (e.g., backward code optimization), the shape and joint code are optimized for each input SDF with Adam first jointly for 400 steps, then only the shape code for 100 steps and finally, only the joint code for 100 steps.

To generate the dataset for the canonical reconstruction task, the aforementioned canonicalization is applied to each object from the object set described above. Here, the placement type does not matter. Then, each object is sampled in 50 joint configurations uniformly spaced within the joint limits, the meshes are made watertight, and 100k ground truth SDF values are generated. Lastly, the generated data is rescaled by the largest extents across all meshes to a unit cube. As mentioned above, the prismatic joint states are rescaled accordingly.

The CARTO reconstruction performance is compare against the category-level object reconstruction method articulated SDF (A-SDF). As A-SDF is designed to work on a single category, first, to show that learning an implicit joint code does not have a negative impact rather than using the real joint state directly as input, in one instance CARTO is compared against A-SDF directly by training CARTO also only on a single category.

Second, CARTO is jointly trained on multiple categories to highlight that CARTO is able to generalize to a wide variety of categories and articulations using one model. Third, an ablation study is performed to understand the importance of the similarity regularization introduced. In this ablation study, the pre-training step and the post-epoch step are removed. This model is referred to as CARTO-No-Enf. And fourth, A-SDF is extended to also take the joint type as input which allows us to train it jointly on multiple categories. Please note that the proposed test-time adaption (TTA) technique for A-SDFs is neglected as in real applications it would not be practical to keep network weights of all different instances encountered.

To measure reconstruction quality, the evaluation provides the bi-directional L2-Chamfer distance (CD) multiplied by 1000 between the ground truth points and the extracted points using the model's respective generation method. To quantify the articulation state prediction, the evaluation reports the joint type prediction accuracy as well as the joint state error measured in degrees or meters depending on the joint type for all correctly classified joint types.

The results for the canonical reconstruction task are shown in Table 2. It is notable that CARTO trained on all categories performs slightly better on average across all categories compared to single category baselines. This shows that having disentangled joint and shape codes in CARTO can make the reconstruction category-agnostic.

TABLE 2
Decoder Optimization Results

| Method | CD (↓) | Joint State Error (↓) | Joint Type Accuracy (↑) |
|---|---|---|---|
| A-SDF | 1.437 | 11.337° (0.094 m) | N/A |
| (single category) | | | |
| CARTO | 1.190 | 12.474° (0.081 m) | N/A |
| (single category) | | | |
| A-SDF | 0.934 | 16.139° (0.235 m) | 0.962 |
| CARTO-No-Enf | 2.246 | 35.892° (0.104 m) | 0.646 |
| CARTO | 1.192 | 11.512° (0.141 m) | 0.908 |

### Full Pipeline Evaluation

The full pipeline task of CARTO was evaluated against a two-stage approach. The full pipeline refers to feeding image(s) to the encoder, which feeds latent codes to the decoder, and then the decoder outputs 3D information per detected object including, for example, joint type, joint state, 3D shape, 6D pose, and/or size. To that end, two experiments were performed: one on simulated (synthetic) data and another on real-world data. The trained decoders (geometry and joint) were used for the full pipeline evaluation. The two datasets allow for the CARTO system to be evaluated quantitatively on the synthetic dataset that aligns with the synthetic training dataset and qualitatively on a newly collected real-world dataset.

To generate a synthetic test dataset, the same procedure may be followed as described herein with respect to generating a training dataset with the only exception that the defined test-instances are used. For example, the test dataset may include unseen instances of articulated objects from the same object categories of the training dataset.

Additionally, the performance of the full pipeline is evaluated on a real-world test dataset. Therefore, two real object instances were selected from each of the following categories: knives, laptops, refrigerators, staplers, ovens, dishwashers, microwaves as well as one storage furniture and washing machine instance. These instances are placed in common household environments. For each object, four different viewpoints were collected for each of the four articulation states for the object. The real joint state is measured and spatial extents of the object is annotated using orientated 3D bounding boxes. In total, 263 images were collected. For collection a ZED 2 stereo camera was used. A learned stereo depth method was used to produce highly accurate depth images.

The evaluation used two derivatives of A-SDF as baselines and followed the proposed method to reconstruct objects in the camera frame. Since A-SDF assumes a given segmentation of the object as well as a pose that transforms the object from the camera frame to the object-centric frame, CARTO is compared against two versions of A-SDF: one, where ground truth segmentation masks and poses are used (referred to hereinafter as “A-SDF-GT”) and another, where the CARTO model predicts segmentation masks, the center of which is then used to query the pixel-level pose map (referred to hereinafter as “A-SDF”). In both cases, the evaluation approximates normals using the depth image, uses the segmentation masks to extract the corresponding object point cloud from the depth image, transforms the point clouds into the canonical object frame using the predicted pose, creates SDF values, optimizes for the SDF values, and eventually re-projects the reconstruction into the camera frame using the same transformation.

The reconstructions in the camera frame are evaluated using two different metrics used for object pose prediction. First, the absolute error of the position and orientation are evaluated as the respective percentage below 10° 10 cm and 20° 30 cm combined. Second, the average precision for various intersection over union (IOU)-overlap thresholds (IOU25 and IOU50) are determined between the reconstructed bounding box and the ground truth bounding box. Both metrics serve as a proxy for articulation state and reconstruction quality.

Tables 3(a) and 3(b) show the results using the aforementioned metrics as well as a speed comparison of CARTO against the baselines, where Det.=Detection time per image, Optim.=Optimiziation time per object, and Recon.=Reconstruction time per object. The speed of the approaches are measured on a common desktop using a Nvidia Titan XP GPU. Sample grid defines how many points are sampled along each dimension. For this evaluation, the total time was the duration of time used to detect two objects.

TABLE 3(a)
mAP Reconstruction Results

| Method | IOU25 (↑) | IOU50 (↑) | 10°10 cm (↑) | 20°30 cm (↑) |
|---|---|---|---|---|
| A-SDF-GT | 45.2 | 27.1 | N/A | N/A |
| A-SDF | 33.9 | 10.4 | 27.1 | 70.8 |
| CARTO | 64.0 | 31.5 | 28.7 | 76.6 |

TABLE 3(b)
Detection Speed of Approaches in [s]

| Method | Sample Grid | Det. | Optim. | Recon. | Total |
|---|---|---|---|---|---|
| A-SDF | 256 | 5.390 | 21.600 | 7.836 | 64.262 |
| CARTO | 256 | 0.264 | N/A | 0.414 | 1.092 |
| CARTO | 128 | 0.264 | N/A | 0.097 | 0.458 |

As shown in Table 3(a), the CARTO full pipeline shows superior performance over both variants of A-SDF for the full reconstruction task. Overall the performance of all methods is lower compared to similar experiments on category-level rigid object detection. This can be attributed to the fact that the kitchen scenarios have heavy occlusions due to many objects being placed under the counter. Taking the occlusions into consideration, for A-SDF, it is very difficult to estimate the exact extents given only a front-showing partial point cloud of the object. Compared to that, CARTO benefits from its single-shot encoding step as the whole image is taken into consideration. Aside from a lower pose and bounding box error, CARTO processes frames faster than A-SDF. Table 3(b) shows a reduction in inference time of more than 60 times while still persevering the same level of detail.

In certain aspects, CARTO is able to generalize to unseen instances of a learned shape (e.g., learned object category). Using test time adaption techniques may improve the detection of unseen instances. Additionally, while the single-forward pass is fast, jointly optimizing for pose, scale, codes could further improve results with the cost of added execution time. In certain aspects, CARTO may be applied to objects with an arbitrary number of joints, for example, by calculating pairwise similarity between two object states. For example, Eq. (8) and Hungarian matching of the cross-product of articulation states may be used to obtain similarities measurements between arbitrary kinematic structures.

The techniques described herein enable reconstruction of multiple articulated objects in a scene in a category- and joint-agnostic manner from a stereo image pair (or a single RGB-D). As demonstrated above, the full single shot pipeline described herein improves over two-stage approaches in terms of 3D IoU and inference speed. This enhanced performance may be attributable in part to the joint space regularization described herein. Thus, the CARTO techniques enable identification of the joint of an object in real-time, and therefore, allow the articulated object reconstruction to be implemented in applications for robotic manipulation, AR, VR, and/or MR.

### Example CARTO Operations

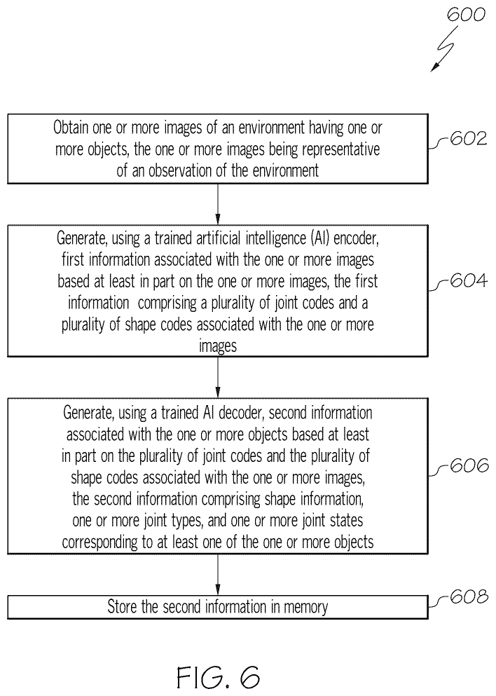

FIG. 6 depicts example operations 600 of object reconstruction using CARTO. The operations 600 may be performed by a processing system, such as the robotic system 100 and/or the controller 108 (for example, for virtual or computer-generated environments).

At block 602, the system obtains one or more images (e.g., the images 116) of an environment (e.g., the environment 104) having one or more objects (e.g., the object 106). In certain aspects, the one or more images are representative of an observation of the environment, where the observation corresponds to a single occasion in time in which the images are captured (e.g., via a camera) or generated from simulation (e.g., as computer-generated imagery). That is, the images may not be captured in a time series, such as video images. As an example, the system captures the images using a camera (e.g., the camera 112) of a robotic device (e.g., the robot 102). In some cases, the images may be or include computer generated imagery, for example, from a virtual environment, such as AR, VR, and/or MR. In certain aspects, the one or more images may include a pair of stereo images, a red-green-blue-depth (RGB-D) image, or a combination thereof. In some cases, the one or more images of the environment may not depict any articulated objects, and the AI encoder/decoder may be trained or configured to indicate that there is no articulated object in the image(s).

At block 604, the system generates, using a trained AI encoder (e.g., the encoder 202 or 300), first information associated with the one or more images based at least in part on the one or more images. In certain aspects, the first information includes a plurality of joint codes and a plurality of shape codes associated with the one or more images. In some cases, the first information further includes a segmentation mask associated with the one or more objects, one or more 3D bounding boxes associated with the one or more objects, one or more poses associated with the one or more objects, a depth map of the images, a heatmap of the images, or any combination thereof, for example, as described herein with respect to FIGS. 2A, 2B, 3A, and 3B. In certain aspects, to generate the first information, the system generates a plurality of feature maps (e.g., the pyramid of feature maps 324) associated with the one or more images based at least in part on the one or more images, for example, as described herein with respect to FIGS. 3A and 3B. The system may use a feature pyramid network that obtains input including a cost volume and a feature map, and the feature pyramid network outputs the pyramid of feature maps. The system infers the first information based at least in part on the plurality of feature maps using the trained AI encoder. For example, one or more output heads (e.g., one or more output layers of a neural network) may obtain the pyramid of feature maps and output the first information, as described herein with respect to FIGS. 3A and 3B.

At block 606, the system generates, using a trained AI decoder (e.g., the decoder 204 or 400), second information associated with the one or more objects based at least in part on the plurality of joint codes and the plurality of shape codes associated with the one or more images. The second information includes shape information, one or more joint types, and one or more joint states corresponding to at least one of the one or more objects, for example, as described herein with respect to FIGS. 2A, 2B, and 4. To generate the second information, the system infers the shape information for each (or some) of the one or more objects using a trained AI geometry decoder (e.g., the geometry decoder 402) based at least in part on the plurality of joint codes and the plurality of shape codes, and the system infers the one or more joint types and the one or more joint states for each of the one or more objects using a trained AI joint decoder (e.g., the joint decoder 404) based at least in part on the plurality of joint codes, for example, as described herein with respect to FIG. 4. In certain aspects, the shape information comprises one or more signed distance functions for each (or some) of the one or more objects (from which the objects surface may be reconstructed through the multi-level refinement procedure for extracting the surface of the object described with respect to Equation (2)); the one or more joint types comprises a prismatic joint or a revolute joint; and the one or more joint states comprises an amount of articulation (e.g., angular displacement or axial displacement) associated with a particular joint.

At block 608, the system may store the second information in memory (e.g., the memory 120). In certain aspects, the system may transform a reconstruction of the articulated object into the environment, such as a virtual environment or a real environment. The system may reconstruct the articulated object in the environment (or a virtual clone of the environment) to consider the joint type and articulation range of the object for object manipulation in the environment and/or the virtual clone of the environment. As an example, the system may control the robotic device based at least in part on the stored second information, for example, as described herein with respect to FIGS. 2A and 2B.

For virtual environments, the system may manipulate the articulated object in a virtual setting based on the second information. For example in a virtual kitchen environment, multiple articulated objects may be in the frame of the images, such as a refrigerator, oven, and microwave. The CARTO techniques described herein may allow the system to reconstruct the articulation of these objects using stereo images or an RBG-D image, which represent a single observation of the environment. The system may virtually manipulate the articulation of the objects and display other computer generated imagery inside the articulated objects. For example, a user or robot may open the refrigerator based on the articulation determined using the CARTO techniques, and the system may display other objects inside the refrigerator, such as eggs, milk, fruit, etc.

In certain aspects, the system may train the AI decoder and/or AI encoder, for example, as described herein. The system may train the AI decoder based at least in part on a joint space regularization among a plurality of articulated objects. The joint space regularization may promote joint space similarities among latent codes of the articulated objects (e.g., between at least two of the objects). A latent joint space similarity may be defined by an exponential kernel of two latent codes. A real joint similarity may be defined through the joint type jt and an exponential distance measure of the joint state q, for example, according to Equations (7) and (8). With respect to training, the AI decoder may be trained to minimize the loss between the joint space similarity of latent codes and real joint similarity. The similarity in the latent space (e.g., the similarities between inputs fed to the decoder) may be representative of the similarity between two joint codes (for example, as given by Equation (7)) corresponding to object(s) in different articulation states. The similarity in the real joint space (e.g., the similarities between the (expected) output of the decoder) may be representative of the similarity between a first set of a joint type and joint state (e.g., joint type jt^{k} and joint state q^{k}) and a second set of a joint type and joint state (e.g., joint type jt^{k} and joint state q^{l}) corresponding to the object(s) in different articulation states, for example, as given by Equation (8). For example, during the training operations of the AI decoder, the system may minimize a joint space regularization loss, which may include an L1-normalization between the latent code similarity and the real joint similarity measurements, for example, according to Equations (9) and/or (10). Note that other loss functions for the joint space regularization loss may be used in addition to or instead of the L1-normalization described herein.

The system may train the AI decoder based at least in part on a plurality of object categories and a plurality of joint types, wherein the one or more objects correspond to at least two or more of the plurality of object categories and at least one of the joint types. The one or more objects may represent at least two of the object categories and at least one of the joint types. As an example, the object categories may include but are not limited to a dishwasher category, a laptop category, a microwave category, an oven category, a refrigerator category, a table category, and/or a washing machine category. In certain aspects, the system may train the AI decoder based at least in part on a plurality of objects and a plurality of joint types. The system may train the AI decoder using training data that corresponds to multiple objects each in a number of different articulation states. The training data may include an association between each object and the respective latent codes (e.g., shape code and joint code). The training data may include labels for each of the latent codes, where a respective label may include ground truth surface information for the geometry decoder and ground truth joint type and joint state information for the joint decoder. The system may train the respective decoders to minimize the loss between the predicted and ground truth information, for example, as described herein with respect to Equations (4)-(6). The latent codes used for training the decoder may be used as the ground truth labels for training the AI encoder. For example, the system may train the AI encoder based at least in part shape and joint code labels obtained from training the AI decoder.

### Example Processing System

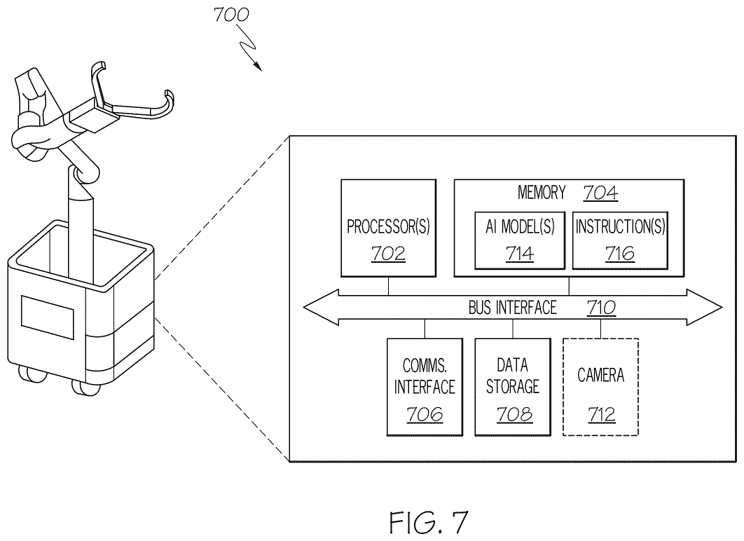

FIG. 7 depicts an example of a processing system 700 that is configured to perform the operations described herein. In some aspects, the processing system 700 is a controller, such as the controller 108 of FIG. 1. One or more of the functionalities and/or components described herein may be provided by the processing system 700.

As shown, the processing system 700 includes one or more processors 702 (hereinafter “the processor 702”), one or more memories 704 (hereinafter “the memory 704”), a communications interface 706, a data storage component 708, and a bus interface 710. In some cases, the processing system 700 also includes a camera 712. The bus interface 710 may facilitate communication among the components of the processing system 700.

The memory 704 may be configured as volatile and/or nonvolatile memory and as such, may include random access memory (including SRAM, DRAM, and/or other types of RAM), flash memory, ROM, secure digital (SD) memory, registers, compact discs (CD), digital versatile discs (DVD) (whether local or cloud-based), and/or other types of non-transitory processor-readable medium. The memory 704 may reside within the processing system 700 and/or a device that is external to the processing system 700.

The memory 704 may store one or more AI model(s) 714 and processor-executable instructions 716, each of which may be embodied as a computer program, firmware, and so forth. The AI models 714 may include the AI models described herein with respect to the CARTO operations, such as the encoder, decoder, and/or any of the underlying models thereof. The processor 702 may access the AI models 714 and the instructions 716 stored on the memory 704. The instructions 716 may include logic or algorithm(s) that execute the CARTO operations described herein. In certain aspects, the instructions 716 may include logic or algorithm(s) implemented via a field-programmable gate array (FPGA) configuration, an application-specific integrated circuit (ASIC), or equivalents. Accordingly, the operations described herein may be implemented in any computer programming language, as programmed hardware elements (e.g., programmable logic), or as a combination of hardware and software components. The processor 702 along with the memory 704 may operate as a controller for the processing system 700. In some cases, the instructions 716 may include an operating system and/or other software for managing components of the processing system 700.

The processor 702 may include any processing component operable to obtain and execute the AI models 714 and/or the instructions 716 from a processor-readable medium (such as the data storage component 708 and/or the memory 704). Accordingly, the processor 702 may be or include one or more of: a microcontroller, a microprocessor, an AI processor, a digital signal processor (DSP), a graphics processing unit (GPU), an FPGA, an ASIC, a system on chip (SoC), a system in package (SiP), an integrated circuit, a microchip, a computer, or any other computing device.

The communications interface 706 may be configured to communicate with other devices. For example, the communication interface 706 may be or include an input/output interface for communicating with auxiliary hardware. In some cases, the communications interface 706 may include a network interface or a wireless communication interface (e.g., a transceiver) used to communicate with other devices, for example, in a data network.

The camera 712 may be or include any device having one or more sensing devices capable of detecting radiation in an ultraviolet wavelength band, a visible light wavelength band, or an infrared wavelength band. The camera may have any resolution. In some cases, one or more optical components, such as a mirror, fish-eye lens, or any other type of lens may be optically coupled to the camera 712. The camera 712 may have a broad angle feature that enables capturing digital content within a 150 degree to 180 degree arc range. Additionally or alternatively, the camera 514 may have a narrow angle feature that enables capturing digital content within a narrow arc range, e.g., 60 degree to 90 degree arc range. In some cases, the camera 712 may be capable of capturing standard or high definition images in a 720 pixel resolution, a 1080 pixel resolution, and so forth. Alternatively or additionally, the camera 712 may have the functionality to capture a continuous real time video stream for a predetermined time period.

In addition to the examples described above, many examples of specific combinations are within the scope of the disclosure, some of which are detailed below:

Aspect 1: A method, comprising: obtaining one or more images of an environment having one or more objects; generating, using a trained artificial intelligence (AI) encoder, first information associated with the one or images based at least in part on the one or more images, the first information comprising a plurality of joint codes and a plurality of shape codes associated with the one or more images; generating, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects; and storing the second information in memory.

Aspect 2: The method of Aspect 1, wherein generating the first information comprises: generating a plurality of feature maps associated with the one or more images based at least in part on the one or more images; and inferring the first information based at least in part on the plurality of feature maps using the trained AI encoder.

Aspect 3: The method of Aspect 2, wherein the first information further comprises: a segmentation mask, one or more three-dimensional (3D) bounding boxes associated with the one or more objects, one or more poses associated with the one or more objects, a depth map, a heatmap, or any combination thereof.

Aspect 4: The method according to any of Aspects 1-3, wherein generating the second information comprises: inferring the shape information for each of the one or more objects using a trained AI geometry decoder based at least in part on the plurality of joint codes and the plurality of shape codes; and inferring the one or more joint types and the one or more joint states for each of the one or more objects using a trained AI joint decoder based at least in part on the plurality of joint codes.

Aspect 5: The method of Aspect 4, wherein: the shape information comprises one or more signed distance functions and their reconstructions for each of the one or more objects; the one or more joint types comprises a prismatic joint or a revolute joint; and the one or more joint states comprises an amount of articulation associated with a particular joint.

Aspect 6: The method according to any of Aspects 1-5, further comprising training the AI decoder based at least in part on a joint space regularization among a plurality of articulated objects, the joint space regularization indicating joint space similarities among the articulated objects.

Aspect 7: The method according to any of Aspects 1-6, further comprising: training the AI decoder based at least in part on a plurality of object categories and a plurality of joint types, wherein the one or more objects correspond to at least two or more of the plurality of object categories and at least one of the joint types.

Aspect 8: The method according to any of Aspects 1-7, further comprising training the AI encoder based at least in part shape and joint code labels obtained from training the AI decoder.

Aspect 9: The method according to any of Aspects 1-8, wherein the one or more images comprises a pair of stereo images, a red-green-blue-depth (RGB-D) image, or a combination thereof.

Aspect 10: The method according to any of Aspects 1-9, further comprising: capturing the one or more images using a camera of a robotic device; and controlling the robotic device based at least in part on the stored second information.

Aspect 11: A system, comprising: one or more memories; and one or more processors coupled to the one or more memories, the one or more processors being configured to cause the system to: obtain one or more images of an environment having one or more objects; generate, using a trained artificial intelligence (AI) encoder, first information associated with the one or images based at least in part on the one or more images, the first information comprising a plurality of joint codes and a plurality of shape codes associated with the one or more images; generate, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects; and store the second information in memory.

Aspect 12: The system of Aspect 11, wherein to generate the first information, the one or more processors are configured to cause the system to: generate a plurality of feature maps associated with the one or more images based at least in part on the one or more images, and infer the first information based at least in part on the plurality of feature maps using the trained AI encoder.

Aspect 13: The system of Aspect 12, wherein the first information further comprises: a segmentation mask, one or more three-dimensional (3D) bounding boxes associated with the one or more objects, one or more poses associated with the one or more objects, a depth map, a heatmap, or any combination thereof.

Aspect 14: The system according to any of Aspects 11-13, wherein to generate the second information, the one or more processors are configured to cause the system to: infer the shape information for each of the one or more objects using a trained AI geometry decoder based at least in part on the plurality of joint codes and the plurality of shape codes, and infer the one or more joint types and the one or more joint states for each of the one or more objects using a trained AI joint decoder based at least in part on the plurality of joint codes.

Aspect 15: The system of Aspect 14, wherein: the shape information comprises one or more signed distance functions for each of the one or more objects; the one or more joint types comprises a prismatic joint or a revolute joint; and the one or more joint states comprises an amount of articulation associated with a particular joint.

Aspect 16: The system according to any of Aspects 11-15, wherein the one or more processors are configured to cause the system to train the AI decoder based at least in part on a joint space regularization among a plurality of articulated objects, the joint space regularization indicating joint space similarities among the articulated objects.

Aspect 17: The system according to any of Aspects 11-16, wherein the one or more processors are configured to cause the system to train the AI decoder based at least in part on a plurality of object categories and a plurality of joint types, wherein the one or more objects correspond to at least two or more of the plurality of object categories and at least one of the joint types.

Aspect 18: The system according to any of Aspects 11-17, wherein the one or more processors are configured to cause the system to train the AI encoder based at least in part shape and joint code labels obtained from training the AI decoder.

Aspect 19: The system according to any of Aspects 11-18, wherein the one or more images comprises a pair of stereo images, a red-green-blue-depth (RGB-D) image, or a combination thereof.

Aspect 20: The system according to any of Aspects 11-19, further comprising: a robot coupled to the one or more processors; a camera communicably coupled to the one or memories and the one or more processors, wherein the one or more processors is configured to cause the system to: capture the one or more images using the camera, and control the robot based at least in part on the stored second information.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method, comprising:
obtaining one or more images of an environment having one or more objects;
generating, using a trained artificial intelligence (AI) encoder, first information associated with the one or more images based at least in part on the one or more images, the first information comprising a plurality of joint codes and a plurality of shape codes associated with the one or more images;
generating, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects; and
storing the second information in memory.

2. The method of claim 1, wherein generating the first information comprises:
generating a plurality of feature maps associated with the one or more images based at least in part on the one or more images; and
inferring the first information based at least in part on the plurality of feature maps using the trained AI encoder.

3. The method of claim 2, wherein the first information further comprises:
a segmentation mask,
one or more three-dimensional (3D) bounding boxes associated with the one or more objects,
one or more poses associated with the one or more objects,
a depth map,
a heatmap, or
any combination thereof.

4. The method of claim 1, wherein generating the second information comprises:
inferring the shape information for each of the one or more objects using a trained AI geometry decoder based at least in part on the plurality of joint codes and the plurality of shape codes; and
inferring the one or more joint types and the one or more joint states for each of the one or more objects using a trained AI joint decoder based at least in part on the plurality of joint codes.

5. The method of claim 4, wherein:
the shape information comprises one or more signed distance functions for each of the one or more objects;
the one or more joint types comprises a prismatic joint or a revolute joint; and
the one or more joint states comprises an amount of articulation associated with a particular joint.

6. The method of claim 1, further comprising training the AI decoder based at least in part on a joint space regularization among a plurality of articulated objects, the joint space regularization indicating joint space similarities among the articulated objects.

7. The method of claim 1, further comprising:
training the AI decoder based at least in part on a plurality of object categories and a plurality of joint types, wherein the one or more objects correspond to at least two or more of the plurality of object categories and at least one of the joint types.

8. The method of claim 1, further comprising training the AI encoder based at least in part shape and joint code labels obtained from training the AI decoder.

9. The method of claim 1, wherein the one or more images comprises a pair of stereo images, a red-green-blue-depth (RGB-D) image, or a combination thereof.

10. The method of claim 1, further comprising:
capturing the one or more images using a camera of a robotic device; and
controlling the robotic device based at least in part on the stored second information.

11. A system, comprising:
one or more memories; and
one or more processors coupled to the one or more memories, the one or more processors being configured to cause the system to:
obtain one or more images of an environment having one or more objects;
generate, using a trained artificial intelligence (AI) encoder, first information associated with the one or more images based at least in part on the one or more images, the first information comprising a plurality of joint codes and a plurality of shape codes associated with the one or more images;
generate, using a trained AI decoder, second information associated with the one or more objects based at least in part on the plurality of joint codes and the plurality of shape codes associated with the one or more images, the second information comprising shape information, one or more joint types, and one or more joint states corresponding to at least one of the one or more objects; and
store the second information in memory.

12. The system of claim 11, wherein to generate the first information, the one or more processors are configured to cause the system to:
generate a plurality of feature maps associated with the one or more images based at least in part on the one or more images, and
infer the first information based at least in part on the plurality of feature maps using the trained AI encoder.

13. The system of claim 12, wherein the first information further comprises:
a segmentation mask,
one or more three-dimensional (3D) bounding boxes associated with the one or more objects,
one or more poses associated with the one or more objects,
a depth map,
a heatmap, or
any combination thereof.

14. The system of claim 11, wherein to generate the second information, the one or more processors are configured to cause the system to:
infer the shape information for each of the one or more objects using a trained AI geometry decoder based at least in part on the plurality of joint codes and the plurality of shape codes, and
infer the one or more joint types and the one or more joint states for each of the one or more objects using a trained AI joint decoder based at least in part on the plurality of joint codes.

15. The system of claim 14, wherein:
the shape information comprises one or more signed distance functions for each of the one or more objects;
the one or more joint types comprises a prismatic joint or a revolute joint; and
the one or more joint states comprises an amount of articulation associated with a particular joint.

16. The system of claim 11, wherein the one or more processors are configured to cause the system to train the AI decoder based at least in part on a joint space regularization among a plurality of articulated objects, the joint space regularization indicating joint space similarities among the articulated objects.

17. The system of claim 11, wherein the one or more processors are configured to cause the system to train the AI decoder based at least in part on a plurality of object categories and a plurality of joint types, wherein the one or more objects correspond to at least two or more of the plurality of object categories and at least one of the joint types.

18. The system of claim 11, wherein the one or more processors are configured to cause the system to train the AI encoder based at least in part shape and joint code labels obtained from training the AI decoder.

19. The system of claim 11, wherein the one or more images comprises a pair of stereo images, a red-green-blue-depth (RGB-D) image, or a combination thereof.

20. The system of claim 11, further comprising:
a robot coupled to the one or more processors;
a camera communicably coupled to the one or memories and the one or more processors, wherein the one or more processors is configured to cause the system to:
capture the one or more images using the camera, and
control the robot based at least in part on the stored second information.
